(19) United States
(12) Patent Application Publication
(10) Pub. No.: US 2026/0134682 A1
(43) Pub. Date: May 14, 2026

(54) VIDEO AND SENSOR DATA FUSION WITH MACHINE LEARNING FOR MANUFACTURING PROCESS MONITORING

(71) Applicant: LightGuide, Inc., Wixom, MI (US)

(72) Inventors: William T. Sommerville, Wixom, MI (US); Ryan J. Feldman, White Lake, MI (US); Miranda R. Perry, Fenton, MI (US); Sanket R. Bagalkoti, Troy, MI (US); Joseph G. Fischette, Fowlerville, MI (US)

(21) Appl. No.: 19/384,580

(22) Filed: Nov. 10, 2025

Related U.S. Application Data
(60) Provisional application No. 63/718,591, filed on Nov. 9, 2024.

(51) Int. Cl. G06V 20/20; G06T 11/00; G06T 13/00; G06V 10/774; G06V 20/40; G06V 20/52

(52) U.S. Cl. CPC G06V 20/20; G06T 11/00; G06T 13/00; G06V 10/7747; G06V 20/41; G06V 20/44; G06V 20/52

(57) ABSTRACT

A manual process guide and monitoring system includes a projector, a vision system, a controller, and a data processor. The vision system includes a camera. The camera is positioned with respect to a work area and configured to capture video of the actions of a worker. The projector is configured to guide the worker performing operational steps in the work area. The controller is configured to collect data related to the operational steps performed in the work area. The data processor is configured to analyze video data from the vision system to detect anomalies in the performance of the operational steps in the work area.

### CROSS REFERENCE TO RELATED APPLICATION

The present application claims priority of U.S. provisional application Ser. No. 63/718,591, filed Nov. 9, 2024, which is hereby incorporated herein by reference in its entirety.

### FIELD OF THE INVENTION

The present invention is directed to a system for monitoring the performance of operational steps, and in particular a system that provides observational and sensor data analysis for a manufacturing execution system.

### BACKGROUND OF THE INVENTION

Conventional manufacturing facilities include workers performing operational steps, such as, in the manual assembly, inspection, kitting, and/or training involved in manual processes or steps. Numerous activities involve the performance of pre-designated operational steps to properly complete a particular task, with some such activities needing to be completed within a specified time or standard time allowance. The performance of such activities can be guided through the use of light guided systems that provide visual prompts and indicators to guide a worker in the performance of their work. Light guided systems can include cameras for monitoring the performance of the operational steps. The performance of the operational steps can also be confirmed by the monitoring of non-visual sensor signals, such as acoustic signals or vibrational signals produced during the performance of the operational steps.

### SUMMARY OF THE INVENTION

Embodiments of the present invention provide methods and an apparatus to improve and/or identify problems with the performance of operational steps by monitoring and evaluating those operational steps. In one embodiment, a manual process guide and monitoring system includes a vision system and a machine learning and/or AI system, as well as may include one or more electronic data input devices for providing operational data to a controller related to the performance of activities taking place at a work area. Such data input devices may comprise, for example, torque guns, light curtains, proximity sensors, vibrational sensors and/or microphones, robot controllers, as well as controllers associated with an operational station providing operator guidance, such as a programmable logic controller (PLC). The system collects data from the data input devices related to the performance of an operation, as well as monitors the cycle time of the operations, such as based on an initiation and a completion signal. The operational data may include operational data from tools used in the work area (e.g., torque tools) as well as operational data related to activities taking place in the work area (e.g., parts arrival, and operator interactions with parts, tools, etc.). The vision system includes one or more cameras that are positioned with respect to a work area to monitor the work area and record actions of the operator related to the guided tasks. The outputs of the cameras may be processed by one or more vision of the vision system, where the vision tools comprise vision algorithms that are operable to detect one or more defined actions of the worker while performing the operation and comparing with data related to the defined actions being overlaid or fused with the recorded video of the operation. The electronic input devices combine data regarding a standard for the operator's performance of the task with the actual data inputs being overlaid or fused with the recorded video from the vision system. Outputs of the vision system with the overlaid identification and/or operational data may be evaluated by a machine learning model for analyzing the performance of the guided tasks, including to evaluate any anomalies that may have occurred during the performance. The machine learning or AI system may include a processor for training the machine learning model based on portions of video data overlaid with associated identification and/or operational data, such as cycle times, with each portion associated with a same identified anomaly, such that the machine learning model is trained to identify the anomaly in other portions of video data overlaid with associated sensor data where the anomaly had not been previously identified. The operational data may also be used as feedback to semi-automated or automated workflows managed/guided by the operational station.

In an embodiment of the present invention, an exemplary manual process guide and monitoring system includes a vision system, a non-vision system, a projected guidance system, and an artificial intelligence-enabled data processor. The vision system includes a camera. The camera is positioned with respect to a work area and configured to capture video of the actions of a worker. The projected guidance system includes a projector for guiding the worker performing operational steps in the work area. The artificial intelligence-enabled data processor is configured to analyze video data from the vision system and sensor data from the non-vision system to detect anomalies in the performance of the operational steps in the work area. Machine learning, traditional algorithms, and hybrid ML/traditional algorithms will take vision inputs and non-vision inputs in order to manipulate the projected guidance (as well as issuing alerts (e.g., signals) to other systems, such as manufacturing execution system (MES), PLC's, quality management system (QMS), and the like).

In an aspect of the present invention, the video data and sensor data are stored in a data storage (e.g., a database, a cloud server, and a file system) for access and processing by a data analytics tool, which performs sensor data analysis and visual data analysis. The video data and sensor data can be archived or live.

In another aspect of the present invention, in addition to the anomaly, the machine learning model is trained to identify a pattern that indicates that a current operational step has been completed.

Thus, a manual process guide and monitoring system includes both vision tools, such as vision algorithms, for monitoring and guiding a worker/operator performing operational steps in a workstation, as well as non-vision algorithms for recording non-visual indicators that detect the worker/operator performing the operational steps in the workstation. The vision algorithms and the non-vision algorithms provide video data and sensor data that when overlayed, can be used to evaluate the performance of the operational steps to detect the occurrence of anomalies as well as variations of productive actions by the worker/operator. By identifying certain anomalies in a series of events characterized with video data and sensor data, a machine learning model can be trained by an AI learning processor to autonomously detect the occurrence of both satisfactory step completion and certain anomalies in real time as they occur in the performance of the operational steps.

These and other objects, advantages, purposes and features of the present invention will become apparent upon review of the following specification in conjunction with the drawings.

### BRIEF DESCRIPTION OF THE DRAWINGS

FIG. 1 is a block diagram of a vision system that includes an arrangement of cameras for monitoring operational activities at a workstation in accordance with the present invention;

FIG. 2 is a block diagram of another vision system that includes an arrangement of projectors to aid in directing the operational activities at a workstation and cameras for monitoring the operational activities at the workstation in accordance with the present invention;

FIG. 3 illustrates an arrangement of the block diagram of the vision system of FIG. 2 that includes an arrangement of electronic data input devices associated with performance of the operational activities at a workstation;

FIG. 4 is a block diagram of an exemplary process monitoring and evaluation system for monitoring the operational activities of a workstation by analyzing sensor and operational feedback data with respect to visual data in accordance with the present invention; and

FIG. 5 is a block diagram illustrating the exemplary fusion of sensor data with respect to visual data for monitoring and evaluating the performance of operational steps at a workstation in accordance with the present invention.

### DESCRIPTION OF THE PREFERRED EMBODIMENTS

Methods and systems of the present invention provide for the monitoring and detection and/or recognition of abnormalities and/or inefficiencies in operational steps performed in a manufacturing setting or the like by the monitoring of operational steps performed by an individual, either a human or a machine. Video data from one or more cameras is recorded of an individual performing a guided task, such as a manual process step or operation. Data associated with the performance of operational steps is obtained, such as by processing of the video data with vision tools, comprising vision algorithms configured to detect defined actions or from electronic input devices associated with the operational steps, such as from, for example, torque guns, light curtains, proximity sensors, vibrational sensors and/or microphones, robot controllers, as well as controllers associated with the operational station at which the operator is being guided, such as a programmable logic controller (PLC). Such monitoring of operational steps (in a manufacturing setting or the like) through the analysis of auditory/vibrational signals is disclosed in U.S. Patent Publication No. 20220004168 (hereinafter the '168 patent publication), which is hereby incorporated by reference. Such monitoring of operational steps, and/or other steps for a given activity are also additionally guided and monitored through the use of a light guided manual process system, such as the operational guide system disclosed in U.S. Pat. No. 7,515,981 (hereinafter '981 patent), which is hereby incorporated by reference. As discussed herein, exemplary embodiments provide for the analysis of sensor signals, hardware signals, tool signals, and video data provided by exemplary vision systems, such that abnormalities and/or inefficiencies in an operational process performed in a manufacturing setting and the like are detected.

An exemplary manual process guide and monitoring system includes both vision tools (comprising, for example, vision algorithms) for monitoring and guiding a worker/operator performing operational steps in a workstation, as well as electronic data input devices for detecting non-visual indicators related to the worker/operator performing the operational steps in the workstation. The vision tools and the electronic data input devices provide video identification data and operational data that when overlayed on the video, can be used to evaluate the performance of the operational steps to detect the occurrence of anomalies. By identifying certain anomalies in a series of events characterized with video data and sensor data, a machine learning model can be trained by an AI learning processor to autonomously detect the occurrence of certain anomalies in real time as they occur in the performance of the operational steps. In one alternative embodiment, the systems described herein can be applied to warehouse applications, such as, part kitting and sequencing, with the added benefit of potentially finding nonconforming parts that would otherwise not be noticed.

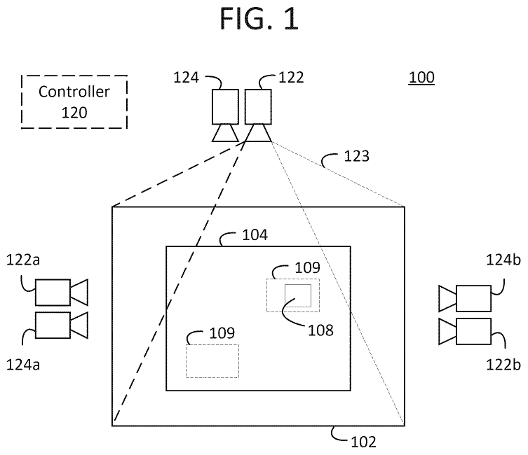

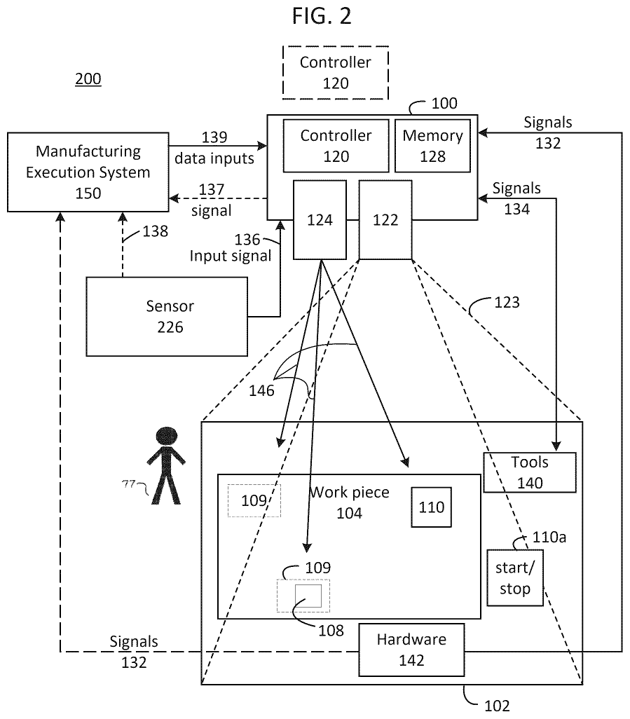

Referring to FIGS. 1 and 2, an exemplary operational light guide system 100, such as disclosed in the '981 patent, is configured for the providing of visual indicators 109 to an operator 77 performing one or more actions, such as manual process steps or actions on a work piece 104 at a work-station 102 of an assembly line. Exemplary light-guided systems 100 are operable, in response to operation information or characteristic or identification information associated with a work piece 104, to selectively provide indicating lights (e.g., visual indicators 109) to guide the operator 77 in the selection and/or assembly, or manual processing of parts or components 108 to a work piece 104. The light-guided system 100 is also operable in response to confirmation signals which may be manually or automatically supplied to verify completion of a particular operation or task. The light-guided system 100 is further operable to provide information (via visual indicators 109) to the operator such as, for example, a listing of steps needing completion, work instructions, images of a work piece, videos, and/or warnings regarding a missed or improperly performed manual process step, as described in detail in the '981 patent, and in U.S. Patent Publication No. 20230409149 (hereinafter '149 patent publication), which is hereby incorporated by reference.

An exemplary vision system 100 includes an arrangement of one or more cameras 122 whose video outputs are received and evaluated by a controller 120 that includes one or more vision programs and vision software. Referring to FIG. 1, a plurality of cameras 122, 122a, 122b and associated projectors 124, 124a, 124b can be arranged around a work area 102 to provide information for an operator 77 working on a work piece 104. While FIG. 2 illustrates a single camera 122 and projector 124 arrangement coupled or communicatively coupled to a controller 120 and associated memory 128 such additional camera/projector 122,124 arrangements may either comprise their own controllers 120 or be communicatively coupled to a single controller 120. The vision system 100 can be implemented with one or more computer systems, each executing one or more vision programs and/or vision software (by accessing respective memories and executing programs in their respective processors), with each vision program receiving and processing video data with respect to relevant vision tools. In one embodiment, the controller 120 is configured to access and execute software comprising vision tools, with each vision tool comprising one or more vision algorithms. Thus, the vision tools may be referred to as vision algorithms. The one or more computer systems can be physically local, networked, or implemented as virtual modules on a single computer, or as virtual modules on the cloud. Each computer system can be communicatively coupled to one or more cameras of the arrangement of cameras (e.g., cameras 122, 122a, 122b). The vision programs and the vision software may be configured and operable to store their data in a memory (e.g., memory 128). As described herein, each vision program is associated with at least one of the cameras (e.g., camera 122, 122a, 122b), with each vision program having one or more configurable vision tools (each comprising one or more vision algorithms), where the vision tools each comprise bounded regions in 3D space within the field of view 123 of a respective camera (e.g., camera 122). The cameras may be configured as smart cameras for detecting defined actions of the operator, such as by detecting and monitoring one or both hands of the operator as tasks are performed, including what parts and/or tools the operator selects and/or uses at various steps in the process. The detecting and monitoring may also include manual process steps or activities, such as for a part or the packaging of components. The cameras may detect the presence or absence of expected objects in the work area, the location and orientation of those objects, and inspect the objects for visual defects and anomalies.

The vision software receives and evaluates indications from the vision programs and their respective vision tools and/or algorithms, and outputs processed results that are received by an exemplary control system 150. The control system 150 may also be referred to as an operational software system. As described in detail in the '981 patent and the '149 patent publication, vision tools may be implemented as defined portions of a camera's field of view. Such a defined portion of the field of view can be defined as a place where a worker or operator 77 can place their hand that is detected by the vision program (operated by the controller 120). By monitoring and detecting a worker's interaction with these vision tools and/or algorithms, and based upon these detected interactions, the vision software (executed by the controller 120) is configured to evaluate those detected interactions and signal the control system accordingly.

Such vision software and vision algorithms may include machine learning vision models that do not rely on a series of vision tools. As discussed herein, such algorithms can detect a particular object, determine if there is a nonconformance, determine object locations and orientations, and even make hybrid determinations that the right objects and operator motions occurred in the proper sequence in time (or else provide granular data to a master machine learning algorithm that incorporates sensor data and other non-vision data). This data may include presence/absence of parts, count of parts or attributes, locations of parts/attributes/defects, other measurements of parts/attributes/defects, or confidence values for the judgement of any of the previous values.

Referring to FIG. 2, an exemplary operational guide system 200 is integrated or interfaced with an operational program system or operational software system or a manufacturing execution system (MES) 150, such as in accordance with U.S. Pat. No. 9,658,614, which is incorporated herein by reference, whereby the MES 150 may provide the operational guide system 200 with input signals or data inputs 139 to create, control, or cause the projector 124 of the operational guide system 200 to project specific display images 109 and interactive images (e.g., virtual buttons) 110 via projected indicating light(s) 146 and/or project in specific locations. In one alternative embodiment, the MES 150 can include or be replaced by a related software like a manufacturing operations management (MOM) system, a supervisory control and data acquisition (SCADA) system, a product lifecycle management (PLM) system, a material requirements planning (MRP) system, an enterprise resource planning (ERP) system, or a production database or historian system. The manufacturing execution system 150 may still further include images of user feedback buttons, known as “virtual buttons” or “soft buttons,” for an enhanced augmented reality environment for the worker 77. Virtual button images or soft buttons 110 may be used to improve the user experience by projecting “buttons” upon the work area 102 (see FIG. 2). Such virtual button images 110 can be “pressed” or activated by the user/operator 77 when 3D sensors are used to monitor the projected virtual button image 110. An exemplary 3D sensor generates 3D images, 3D point clouds, or 3D encoded data based on time-of-flight calculations. Alternatively, an exemplary 3D sensor is a structured light sensor. In a further alternative, an exemplary 3D sensor is a stereo sensor with a pair of sensors (e.g., cameras 122, 122a, 122b). In a further alternative, exemplary 3D information may be obtained using regular cameras (i.e., USB webcams) stationed around the area such that the operators'hands can be seen by at least two sensors at any given time. In a further alternative, exemplary 3D information can be obtained using only one regular USB webcam, or the like, that can determine depth and orientation of objects using their apparent size and orientation using machine learning or mathematical algorithms. In one exemplary embodiment, a calibrated 3D camera or sensor can directly measure the work surface topology and enable the system to locate features to project onto as well as distort the projected images to achieve the desired look at different shaped or angled surfaces.

Machine vision aspects of the video output of the camera 122 and the controller 120 detect the worker/operator 77 interacting within/upon a virtual button image 110 (displayed by the projector 124 upon the work area/work station 102), such as by detecting the worker/operator 77 placing a finger or making a hand gesture within/upon the virtual button image 110. Such detected/determined user interaction (with the virtual button image 110) is then used by the controller 120 as an input that the particular virtual button has been “selected” or activated by the worker/operator 77. For example, an exemplary virtual button image 110 may be configured to indicate to the controller 120 that the worker/operator 77 is ready to start a task, that a task step has been completed, or that a current task is being paused. In an aspect of the present invention, a particular virtual button image 110a may be “programmed” for a particular indication (e.g., start or stop a task) by assigning a text (e.g., “start/stop”) to be displayed by the projector 124, such that when a worker/operator 77 is detected or determined to have interacted with the “start/stop” virtual button image 110a, the controller 120 interprets the detected interaction with the virtual button image 110 a, as an indication by the worker/operator 77 to start or stop the task (depending on context).

In additional to the enhanced augmented reality displays that include information display images/animations 109 and user-feedback “virtual button” images 110, other data acquisition devices 142, including various hardware devices, are used in a work area/work station 102 that outputs digital or analog signals 132 that are received and analyzed by the controller 120 of vision system 100 incorporated in the guide system 200. The devices 142 may include, for example, electronic tools, gauges, weight scales, or sensors, such as light curtains, proximity switches, vibration sensors, microphones, and the like, as well as other electronic components from which a data signal (e.g., signals 132) can be generated. The devices 142 may also include other controllers for the operational system. For example, a controller such as a PLC may provide data and/or informational signals related to a part entering and/or exiting a workstation, including the type of part. These signals 132 can be used by the controller 120 to aid in determining when to advance the work instructions to perform the work task. Thus, the signals 132 may be used to indicate via display images/animations 109 information or instructions to the worker/operator 77. As illustrated in FIG. 2, an exemplary hardware/sensor 142 includes sensor 226, which outputs an input signal 136 to the controller 120 as well as a signal 138 to the MES 150. Thus, data signals 132 whether sent directly, or passed through the controller 120, can also be received by the MES 150.

The output signals 132 may be used to control or modify the operation of physical hardware (e.g., tools 140) at the work area/workstation 102. Such tools 140 may include, for example, tools with sensing and communication capabilities (output or received via control and/or data signals 134). For example, if the worker/operator 77 performs a particular task with a particular piece of hardware or tool 140 (e.g., a torque tool) to perform four tasks with a timed duration between one minute and two minutes (torquing four bolts), the system may enable hardware/tools 140 at the one minute mark via control signals 134, wait for four positive activity signals (e.g., torque tool activation signals when using the torque tool to torque four bolts) to come back via the signals 134, disable the hardware/tool 140 at this point via control signals 134, and then provide feedback to the worker/operator 77 about any pass/fail status of the four tasks completed with the hardware/tools 140 as well as providing how long after the 1 minute mark the worker/operator 77 took to complete all four tasks (torque operations), for example, via signals 134. As discussed herein, data from such tools 140 provides for the collection of operational data directly from tools 140 used while performing operational activities (e.g., torque tools) as well as operational data acquired by monitoring the operational activities taking place in the work area/workstation 102 (such as via hardware 142). For example, the operational data collected from hardware 142 may include sensors detecting the arrival of parts to the work area 102, and operator interactions with those parts. By monitoring the timing of events and/or activities at the work area 102, the performance of operational activities at the work area 102 can be monitored and measured (e.g., timing how quickly an operator performed an activity or responded to the arrival of new parts at the work area 102). The operational data may also be used as feedback to semi-automated workflows managed/guided by operational guidance systems at the work area 102. Such semi-automated workflows may include operators and machines working together on operational tasks, such that the manufacturing execution system 150 may utilize a holistic view of the operational activities taking place at the work area 102 to provide the right guidance and analysis (as well as providing the proper control signals to machines operating in the work area 102).

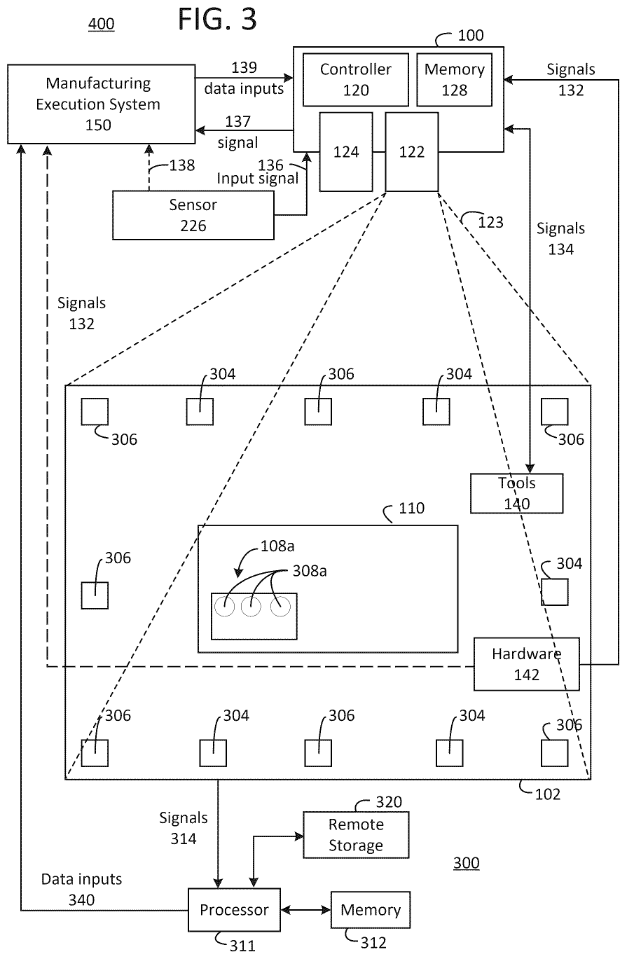

Referring to FIG. 3, while the manufacturing execution system 150 may interact with guide systems 200 (that includes a vision system 100 with one or more cameras 122 and projectors 124) to guide and monitor the operational activities taking place within a workstation 102, as noted herein, the hardware 142 may also include acoustic and/or vibrational sensors, such as described in detail in the '168 patent publication. FIG. 3 illustrates an exemplary acoustic or vibration monitoring system 300 for monitoring an individual/operator 77 performing one or more steps of a given operational task, with the acoustic and/or vibration monitoring system 300 including one or more microphones 306 and/or transducers 304. In the performance of various operational steps (e.g., the assembly, or manual process steps, of electrical connectors), microphones 306 can be used to monitor for assembly sounds of connectors being connected. The microphones 306 will detect sounds emanating from the actions of the operator, such as the “click” or other identifiable sounds generated by assembly or manual process steps or operations. These sounds can be transmitted as audio signals (e.g., signals 314) to processor 311 for analysis and recording/storage in memory 312 (or remote storage 320). The identifiable sounds comprise sounds that are sufficiently repeatable whereby they can be recognized via a control system (e.g., processor 311) detecting the sounds, such as by an acoustical detection algorithm running on a controller/processor 311. Optionally, the microphone 306 may be configured as a stationary, unidirectional microphone, or configured as a microphone array designed for noise rejection. Such a microphone array can additionally be used to determine sound source location to, for example, discriminate between two different connectors located near each other, so it can be determined which one was connected.

Referring to FIG. 2, and 3, in an exemplary manual process guide and monitoring system 400, an embodiment of the acoustic and vibration monitoring system 300 may be coupled with an embodiment of the light-guide system 200 (that includes one or more vision systems 100, each with at least one camera 122 and projector 124). For example, a part 108 present at a particular workstation 102 may be determined by the camera 122 by detecting the geometrically distinguishing features of a work piece or the structure upon which it is located to “identify” the work piece or the component to be attached to the work piece. In other words, where the light-guided system 200 guides the operator 77 through the majority of the operational steps, the acoustic and vibration monitoring system 300 may be used to monitor the performance of those operational steps that are unable to be performed with the use of the light-guided system 200. As illustrated in FIG. 3, the acoustic and vibration monitoring system 300 and the light guide system 200 are each communicatively coupled to an exemplary manufacturing execution system 150, each configured to transmit data signals (e.g., data inputs 139 and data inputs 340) to the MES 150. While the light-guided system 200 can be used for guiding the performance of the operational steps, the acoustic and vibration monitoring system 300 can be used to inspect the individual operational steps as an additional verification of the proper performance of the operational steps. As described in detail in the '168 patent publication, responsive acoustical or vibrational signals may be analyzed to determine whether a component is properly configured or assembled. Machine learning may also be employed to generate an appropriate algorithm for confirming proper assembly or a proper manual process step, as well as providing a signal as to potential defects based on learned known outcomes of improper assemblies.

Thus, a manual process guide and monitoring system 400 may be configured to utilize both light sources, audio, ultrasonic, electromagnetic, and/or similar technology to guide and confirm assembly or other manual process steps.

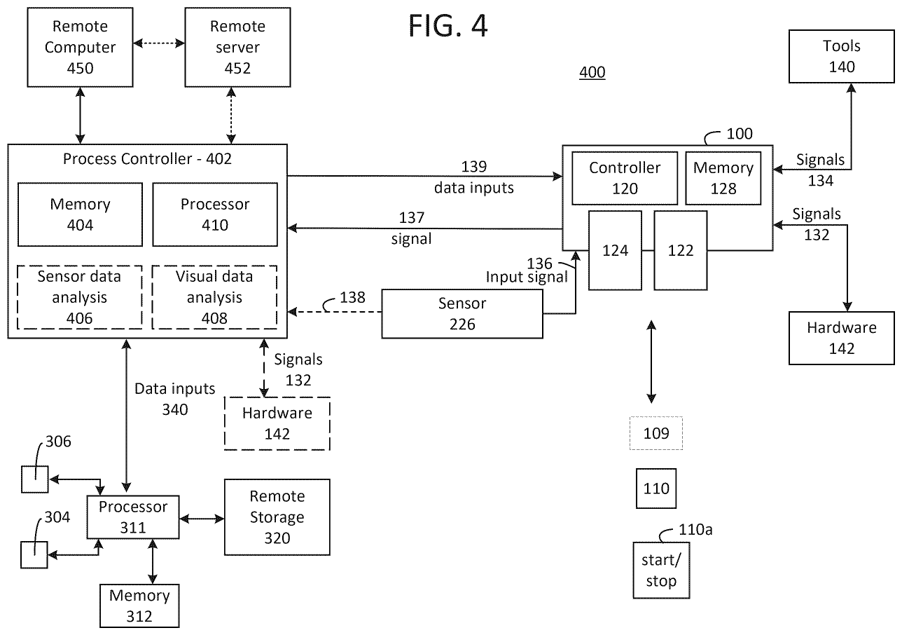

Referring to FIG. 4, an exemplary processor controller 402 of, for example, a manufacturing execution system 150, is configured to receive, monitor, and analyze a plurality of different sensor signals, such as, data inputs 340 from the processor 311 of an exemplary audio and vibration monitoring system 300, signal 137 from the controller 120 of an exemplary light guide system 200 (which can also include sensor signals 138 from sensor 226, and signals 132 from hardware 142 and feedback from operator interactions with virtual buttons 110, such as the start/stop button 110a). Note that sensor 226, as one of the hardware 142, can refer to any one of a plurality of different sensors for guiding and/or monitoring the manual process guide and monitoring system 400, e.g., torque sensors, torque guns, proximity sensors, light curtain, and smart camera output.

The process controller 402 may be used to monitor the various forms of sensor data and record various parameters useful for improving productivity. For example, the process controller 402 may record cycle times of the individual operational steps at a workstation 102 and/or the combined cycle time of operations at a workstation 102. Correspondingly, the process controller 402, or another such computational device, may record and provide charts or reports regarding recorded error data, such as on mis-performing steps, and/or cycle times (with such data stored, for example, in memory 404). In addition, such data may be linked or otherwise networked, or even monitored via the Internet, such that the variously above noted cycle times or performance parameters may be monitored from a remote computer 450, with such data (from sensor data) being viewable in a live format or archived. An exemplary remote computer 450 may be communicatively coupled to the process controller 402 via a network connection, Internet connection, or other suitable communications links, and the like.

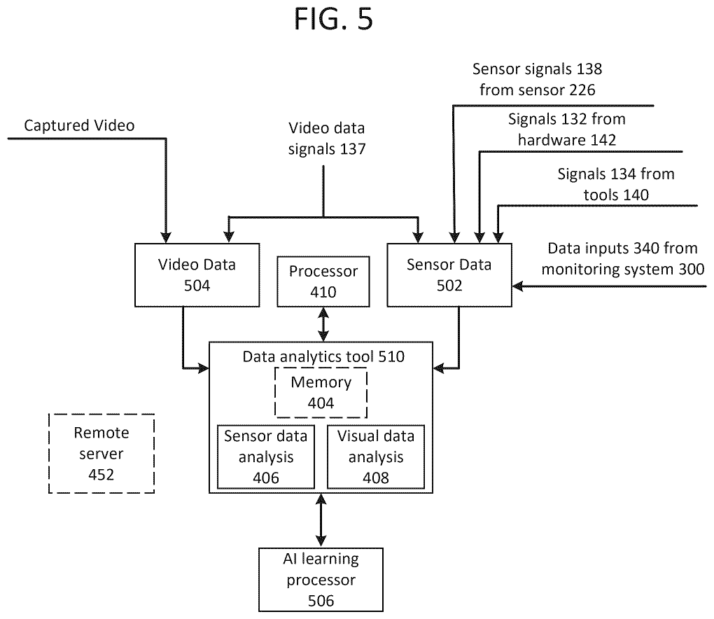

Referring to FIGS. 4 and 5, sensor data 502 (e.g., data inputs 340 from the processor 311 of the audio and vibration monitoring system 300, sensor signals 138 from sensor 226, and signals 132 from hardware 142, and video data signals 137 from the controller 120 of the light guide system 200 (e.g., feedback from operator interactions with virtual buttons 110, such as the start/stop button 110a)) and video data 504 (e.g., captured video and video data signals 137 (which can also include data and/or output from smart cameras) are received by the process controller 402 for training an exemplary manual process guide and monitoring system 400 via an AI learning processor 506.

When a video feed is captured by, for example, camera 122, the resulting captured video feed (e.g., a digital video recording) can be reviewed and analyzed with, for example, a video editing software (e.g., visual data analysis 408), the captured video can be “scrolled” in time to specific points in time within the captured video recording. In one embodiment, the captured video recording (e.g., video data 504) is overlayed with selected sensor data 502 in a data analytics tool 510. Such overlayment of the video recording with sensor data can be performed by software within the data analytics tool 510, by the process controller 410, and/or manually via user interaction with these computer systems. This, while an operator or engineer may choose which sensor data 502 to overlay on the video data 504, the selected sensor data 502 may be chosen by an algorithm, including a machine learning algorithm. For example, an algorithm may recommend signals to use as sensor data 502 in the overlay, even if different signals are already in use, in order to help the system improve. An exemplary overlayment of sensor data 502 on or with video data 504 may include adding visual representations of the sensor data 502 to the video data 504 to produce a composite image for analysis. In an alternative embodiment, the sensor data 502 and the video data 504 are separately analyzed in parallel. It is understood that the overlayment of the sensor data 502 onto the video data 504 is intended to help reviewers to draw conclusions from the sensor data 502 and/or the video data 504. As discussed herein, in training a machine learning model, a sensor data-only model and a video data-only model can be used together to train the machine learning model. When reviewed by an engineer (e.g., a process engineer) or another reviewer, an exemplary overlayment of the sensor data 502 onto video data 504 may be combined with a known process sequence of operational steps, such that the reviewing engineer can “drag” operational steps to coincide with data signals, detected objects in the camera, or some combination, so that a process context is better understood or known. Using such methods, anomalies can be tied to the underlying process for better understanding by, for example, process engineers, quality managers, and others.

As discussed herein, the sensor data 502 can include outputs from vision tools (e.g., interactions with virtual buttons 110, 110a that have monitored, as well as any further analysis of the video recording, as discussed herein and described in detail in the '981 patent and the '149 patent publication), an input signal 136 from sensor 226 (which includes, for example, torque sensors, torque guns, proximity sensors, light curtain, and smart camera output), signals 132 from hardware 142, signals 137 from the vision system 100, and data inputs 340 from the processor 311 of the acoustic and vibration monitoring system 300 (which includes signals 314 from the microphones 306 and the vibration sensors 304). Thus, the sensor data 502 comprises, for example, vision tool signals, PLC tag values, such as, Boolean (true/false) or integer data, recorded torque events from torque sensors and torque guns, recorded torque values, as well as proximity sensor outputs, light curtains and their related indications or events, and smart camera output, and the like, which can be overlayed on the video data 504 in chronological order. By overlaying the sensor data 502 on the video data 504, particular sensor “events” in the sensor data 504 are tied or associated chronologically to the corresponding video record. The timeline or chronological order of the sensor data events can be used to evaluate the video recording (video data 504) of an exemplary workflow by, for example, sensor data analysis 406 and visual data analysis 408, such that the video recording can be broken up into a series of identified events or steps, as well as identifying those events that signal the beginning and/or ending of the identified events or steps. The sensor data analysis 406 and/or the visual data analysis 408 could identify data points (e.g., signals) that were used during the workflow to advance from step to step (e.g., selecting the start/stop button 110a, using a tool 140, etc.).

Referring to FIGS. 4 and 5, data collections (e.g., sensor data 502 and video data 504) can be stored and/or archived for a plurality of workflows. After each respective workflow has been completed, the resulting collection of data (from multiple workflows) can include data gathered for multiple operational steps (e.g., torque values, start/stop times, related sensor data, etc.). In one embodiment, the data is gathered for one or more particular operational steps of interest in a manufacturing workflow. These data collections can be stored in an exemplary local memory (e.g., memory 404) or a remote memory (e.g., remote server 452) accessed by the data analytics tool 510. The local or remote memory 404, 452 can reside in either a local computer system or a remote computer accessed via a network, respectively. In one embodiment, the data analytics tool 510 resides within the process controller 402. Alternatively, the data analytics tool 510 can be accessed by the processor 410 of the process controller 402 via a remote connection. In one exemplary embodiment, a data collection includes a recording of the sensor 502 and video data 504 captured for each of 10-100 cycles of a particular operational workflow.

The data analytics tool 510 retrieves the collection of data from memory/storage 404, 452 and presents the collection of data for review for one or more operational steps of a workflow to detect or determine whether there are anomalous events that took place during the workflow. For example, the data analytics tool 510 can be used to analyze the collected data for anomalous events (e.g. torque values recorded during one or more operational steps that were outside of the expected range of torque values, elapsed times for a particular step that were outside of the expected range of step durations). Thus, related sections of the process could be flagged for review and analysis (e.g., by an engineer and/or the user/operator 77). In one embodiment, the data analytics tool 510 stores the collected data in a local memory (e.g., memory 404) or in a remote memory (e.g., remote server 452). The data analytics tool 510 includes the sensor data analysis 406 and the visual data analysis 408. Alternatively, the process controller 402 includes the data analytics tool 510 (and the sensor data analysis 406 and the visual data analysis 408). The data analytics tool 510 can include or access the local memory (e.g., memory 404). In one embodiment relevant video clips (from the video data 504) that were recorded while those anomalous events were occurring, could be extracted and tied to the relevant sensor data 502 that indicated an anomalous event. In one embodiment, the sensor data analysis 406 and visual data analysis 408 is performed by the processor 410 of the process controller 402 (that is, the processor 410 includes the functionality of the data analytics tool 510). In another embodiment, the sensor data analysis 406 and the visual data analysis 408 can comprise logic and/or computational modules, and/or software modules for performing their respective analysis tasks. In a further embodiment, the sensor data analysis 406 and the visual data analysis 408 utilizes manually identified (e.g., by an engineer, user, or operator) steps and/or events as well as any steps and/or events that have been identified by the sensor data analysis 406 and the visual data analysis 406 (e.g., torque values and/or elapsed times that are out of expected ranges). In an additional embodiment, the sensor data analysis 406 and the visual data analysis 408 identifies each of the steps and/or events in the visual data 504 with respect to the overlaid sensor data 502. In a further embodiment, a reviewer (e.g., the user/operator 77), uses the sensor data analysis 406 and the visual data analysis 408, to identify the steps and/or events in the visual data with respect to the overlaid sensor data 502.

As an initial step, the identified events (whether visible in the video data 504 and/or contained in the sensor data 502) can be used to identify whether an anomalous event has occurred. For example, whether sensor data (e.g., torque values and/or elapsed times for operational step completion) and/or video data (e.g., smart camera output showing unexpected operator actions, component or work piece positioning/orientation not in an expected configuration) is identified as being “out of range” or “unexpected,” for example, can be identified or determined by the user/operator 77, another reviewer (e.g., an engineer reviewing the resulting data), or as determined by the processor 410 using, for example, a machine learning model that has been trained to identify particular anomalous events.

With machine learning, using the AI learning processor 506, once an initial collection of “anomalous events” with their relevant sensor data (from sensor data 502) and corresponding video clips (from the video data 504) of the anomalous events have been gathered by the data analytics tool 510 for storage in a local or remote memory (e.g., memory 404 and remote server 452, respectively) (e.g., the anomalous events are manually identified by the user/operator 77 or another reviewer, or as a collection of previously identified anomalous events), the collection of anomalous events (defined by the relevant sensor data and corresponding video clips) can be reviewed (by the user/operator 77 or another reviewer) to ensure that each anomalous event is a true anomalous event and not related to or caused by a statistically irrelevant event, e.g., an operator goes on break and leaves the workstation, rather than a delay due to a problem or incident during a step within the workflow process.

Once a series of “genuine” anomalous events have been identified as anomalous events, an AI learning processor 506, using machine learning, can utilize the collections of video clips (and associated sensor data) stored in the local memory 404 or remote server 452) to teach a machine learning model to identify that an anomalous event has occurred. That is, by providing the AI learning processor 506 with a series of identified anomalous events (i.e., video clips and associated sensor data collections), each with a same identified anomalous event, the AI learning processor 506 can teach a machine learning model to identify and detect a particular anomalous event that the machine learning model had not previously been trained to identify. Thus, once trained, a machine learning model, trained by the AI learning processor 506, is able to access the data analytics tool 510 (and the video data 504 and associated sensor data 502 stored in memory (e.g., local memory 404 and remote server 452) and evaluate the recorded workflow for a particular operational step or collection of operational steps and identify any anomalous events that the machine learning model has been trained to identify. Thus, the manual process guide and monitoring system 400, using the AI learning processor 506, is operable to detect defects and/or anomalous events in a manufacturing process (by reviewing the recorded video data 504 and associated sensor data 502). In one embodiment, the processor controller 402, using the machine learning model, is operable to access archived video data 504 and sensor data 504 stored in the memory (e.g., local memory 404 and remote server 452) for training purposes or to detect anomalies in the video data 504 and sensor data 504 (which is overlayed on the video data 504 by the data analytics tool 510). In another embodiment, the machine learning model is operable to access live or current video data 504, overlaid with live or current sensor data 502 to detect anomalies in the performance of operational steps of a manufacturing workflow. That is, the processor controller's machine learning model, when tried to identify particular anomalous events, is able to review previously stored video data 504 and sensor data 504 to identify the presence of those particular anomalies in that stored data, or to access live or current video data 504 and sensor data 502 to identify the presence of those particular anomalies in that live data as one or more of those particular anomalous events are taking place.

In one embodiment, when a new installation with a new manufacturing workflow with operational steps is being deployed, the AI learning processor 506 can begin a baseline training of a machine learning model to detect anomalies in the operational steps of the new manufacturing workflow by starting with an archived collection of video data 504 and sensor data 502 stored in the memory (e.g., local memory 404 and remote server 452). In an alternative embodiment, the archived collection of video data 504 and sensor data 502 can include or comprise synthetic data. The archived data can be for different, but relevant, manufacturing processes, parts, and workflows, but would provide a way for the AI learning processor 506 to begin training the machine learning model to at least a “baseline” level as a starting point to detect anomalies within the new manufacturing workflow. That baseline level of training would include training for the machine learning model to identify one or more anomalous events in that archived collection of video data 504 and sensor data 502. Thus, such baseline training can be used as a starting point for future training to identify additional anomalous events.

In one embodiment, an exemplary manufacturing process can include a plurality of operational steps for the assembly of, for example, a fuel injector. After each operational step of the assembly or manual process, workflow, the operator 77 can press a virtual button image 110. In one embodiment, out of 100 process assembly or manual process workflows, the time taken by the operator 77 to press the soft button at the completion of the operational step can be statistically longer than expected. Thus, this soft button data can be collected by the data analytics tool 510 and evaluated. As discussed herein, there would also be associated video recordings (e.g., video data 504) of every time the operator 77 took longer than expected to press the virtual button image 110.

Whether there is a statistically significant delay in the completion of the operational step can be determined through statistical analysis (with the identification of statistically longer times than the average time stamps for operation step completion). When these events when there was a detected, statistically significant delay in pressing the virtual button image 110, the video feeds (and associated sensor data) can be evaluated to determine if there is a reason for the delay (e.g., in certain of the steps, the work piece 104 fell over or was shifted out of place and this delayed the operator 77). The camera (e.g., camera 122) has a video recording of each event within the operational step. Thus, in reviewing the video recordings, it can be seen that while there were events where, for example, the work piece 104 fell over or was shifted, in other events, it can be seen that the delay was caused by a distracted operator 77 and not anything wrong with the operational step process (i.e., the delay was not due to a statistically significant reason). A human reviewer can then review these events to determine whether a true anomaly occurred during the performance of the operational step. By identifying those events where an anomalous event occurred, the video data 504 and sensor data 502 for those particular events can be used by the AI learning processor 506 to train a machine learning model to learn how to detect that particular anomalous event (e.g., a work piece 104 tipping over or shifting position on the workstation 102). From then on, the AI learning processor 506 will have trained the machine learning model to identify that particular anomalous event. Such exemplary machine learning may also include teaching the machine learning model to recognize the so-called “distracted operator” and can report both details or events related to “what is wrong with the operational step process” and other cases (e.g., distracted operators) so that a complete picture of the event(s) taking place at a work area 102 can be captured and/or analyzed.

As discussed herein, there are sensor inputs via soft or virtual button images 110, 110a that can be used to help identify those anomalous events. Because the virtual button images 110, 110a are used at certain times (e.g., start/stop), a machine learning model trained by the AI learning processor 506 can know (based on what it sees) as the soft buttons are pressed, what to look for to know that the step is complete. Thus, the AI learning processor 506 can be used to train the machine learning model to identify the anomalous events as well as to identify when a workflow has completed. Once the machine learning model has identified when an operational step of a workflow has been completed, the machine learning model could be trained to advance the manual process guide and monitoring system 400 onto the next step in the manufacturing process. That is, with enough training, the machine learning model can be trained to advance the workflow to the next step without the operator having to press the virtual button image 110. In one embodiment, the machine learning model as an manual process guidance model resides within the processor 410 of the manual process guide and monitoring system 400. Thus, exemplary machine learning models can be trained by the AI learning processor 506 to detect anomalous events that occur during monitored operational steps of a workflow and for pattern recognition (e.g., to identify when an operational step of a monitored workflow has been completed).

It understood that a variety of different sensor data 502 (and/or video data 504) can be used by the AI learning processor 506 to train the machine learning model to identify anomalous events based on that sensor data 502 and/or video data 504. For example, rather than considering “time to completion” of operational steps, the machine learning model can be taught on torque values or other measurable events or sensor readings that can be evaluated with respect to statistically significant outliers.

In one embodiment, the video data 504 and sensor data 502 can include depth tool output signals (from depth cameras and/or 3D cameras), and programmable logic controller (PLC) data to identify identifiable anomalies. In one embodiment, the PLC is configured to inform the system that a requested part has arrived at the manufacturing facility or at a particular workstation 102. For example, as an exemplary pallet arrives at a workstation, sensor 226 (e.g., a proximity sensor) at the workstation detects the presence of the requested component 108. Note that the arriving part may be of one or more varieties, such that the related data is categorized for different part or work piece variants. In one embodiment, the machine learning model will have different models for each part or work piece variant. Thus, the machine learning model can be “tailor-made” for a specific manufacturing process. In one embodiment, the machine learning model can include a video-only model and a sensor data-only model such that the sensor data 502 and the video data 504 are separately analyzed to train the one or more machine learning models.

As discussed herein, the identification of anomalies can be based on more than just the video data 504. There are times when the video data 504 will not provide enough evidence of an anomaly for the trained machine learning model. For example, using just video data 504, an exemplary machine learning model may be only 50% certain that a particular anomaly took place), but the machine learning model would be able to identify the particular anomaly when the video data 504 is overlaid with related sensor data 502. Thus, when the sensor data 502 is combined (i.e., overlaid upon) with the video data 504, anomalies can be readily identified (with the confidence of the machine learning model rising as sensor data 502 is integrated with the video data 504). In one embodiment, operator input could also be used to identify when an anomaly has occurred. For example, the operator 77 at a work area/workstation 102 could use a soft button (e.g., a virtual button image 110), physical gesture of the operator 77, voice command, or other input to tell the system (e.g., process controller 402 and/or the MES 150) that an anomaly happened. Such an anomaly could be, for example, a bad part, a bathroom break (or other break where the operator 77 chooses to stop work and leave the work area 102), and the like. Such “real-time” tagging by the operator 77 could result in the identification of anomalies as they occur, rather than requiring an assessment after the fact. Such collaboration between operators 77 and engineers reviewing the collected data (e.g., sensor data 502 and video data 504) can allow for the operators 77 to assist in identifying readily apparent anomalies and allow the reviewing engineers to focus on the identification of more complicated (and less easily identifiable) anomalies. Thus, having operators 77 help with the identification of anomalies, combined with the intelligence of the collection of data (both video and sensor data), can drastically reduce the time commitment of the reviewing engineer and makes the system more accurate.

As discussed herein, the sensor data 502 (e.g., from sensor 226 and hardware 142) can include other types of data: PLC data, torque data, depth data (from 3D or depth cameras or from vision algorithms), and smart vision models outputting data for skeletal tracking, gesture recognition, and object recognition, and thereby providing coordinates of where the operator's hands are, or where the work piece 104 is within the workstation 102. Other sensor 226 and hardware 142 outputs can include smart cameras, barcode scanners, RFID readers, proximity sensors, light curtains, and robot data (e.g., position data, and robot controller outputs). Thus, any sensor (e.g., sensor 226) that can output to the system 400 can be used and integrated with (overlaid upon) the video data 504 to train the machine learning model to detect different anomalies. Note, a smart vision program's vision model can be used as an input to train the machine learning model by the AI learning processor 506.

In one embodiment, the detection of anomalies is segregated by operator and timestamp, such that the analysis will be operator and work piece specific. Such a process can consider and account for specific processes, such as, “low runners,” change-over times, and other statistically significant events (but otherwise operationally irrelevant with respect to data analysis) that can skew the statistical analysis of the performance of the operational steps of a manufacturing flow. By segregating the detection of anomalies by operator, a particular operator's data can be compared with their own prior performance as well as the performance of other operators, such as a composite normal performance (a statistical “average”) of all operators. Such an assessment could be used, for example, to detect a “bad day” for an operator and help supervisors manage them better.

The collected data (e.g., sensor data 502 and video data 504) can also be aggregated between work areas/workstations 102 in a facility, such that a review of the collected data from an aggregation of work areas/workstations 102, can show, for example, that each of the operators 77 stopped for lunch at the same time. Such a review could also be used to identify other facility-wide work stoppages (e.g., an all-hands meeting). Such aggregation of collected data could also be used to identify anomalies produced at an upstream work area/workstation 102 such that a machine learning model guiding and monitoring the operational activities at a downstream work area/workstation 102 could be informed that a part to be received is a suspected “bad part.” Such warning or alerts could be used to adjust or identify expected or suspected anomalies associated with the suspected “bad part” and react accordingly (e.g., directing alternative operational steps to review or remedy the suspect part).

Statistical analysis of the video data 504 and sensor data 502 by the data analytics tool 510 can be implemented where outlier data is removed when flagged as statistically irrelevant versus data points that are statistically significant. This allows for irrelevant data points to be filtered out (e.g., operator breaks, part outages, etc., leading to start/stop delays). Such statistical analysis will provide for better detection and/or identification of anomalies on future cycles.

In one embodiment, the training of the machine learning model (used by the manual process guide and monitoring system 400) can incorporate downstream test data, warranty data, and other quality information sources to improve the machine learning model. For example, a particular operator might make thousands of parts over months and result in, for example, 50 warranty claims coming in. A root cause for the warranty claims (e.g., due to defective end products) for this particular operator could be evaluated and identified using the machine learning model. Such a review of known outlier defective parts (e.g., identified from warranty claims or other complaints) could be incorporated into Industrial Internet of Things (IIoT) systems. Such IIoT systems could use machine learning to train or use models for guidance of operational steps in IIoT systems to identify anomalies that occur in the IIoT systems.

In one embodiment the machine learning model, as used by the manual process guide and monitoring system 400, can be used to guide an operator 77. For example, by analyzing live video data 504 and sensor data 502 (as it is captured) the machine learning model can guide the operator 77 in knowing when to move on to a next operational step in an ongoing manufacturing process. Furthermore, when analyzing the live video data 504 and sensor data 504, the machine learning model can be taught to detect certain anomalies in real time and to provide guidance or directions to the operator 77. For example, when a particular anomaly is detected by the machine learning model, the manual process guide and monitoring model 400 can guide the operator 77 to a subroutine for dealing with the detected anomaly. Such a subroutine can provide guided steps for dealing with the issue proactively as the anomaly occurs in real time. Thus, the system can offer the operator 77 guidance in response to detected anomalies (e.g., offering repair information, ask the operator 77 to confirm that a suspected anomaly actually occurred, activating a signal light (or the like) to attract help to the work area/station 102 in real-time). By confirming that an anomaly actually occurred, the machine learning model can be trained to be more accurate. In addition to guiding an operator in handling a detected anomaly, the system can also be used to assess the end result (i.e., did the projected guidance for handling the anomaly help or hurt compliance?).

In another embodiment the machine learning model, as used by the manual process guide and monitoring system 400, can be used to aid an engineer or user (e.g., operator 77) in troubleshooting or researching anomalies. For example, by analyzing recorded video data 504 and sensor data 502 (retrieved by data analytics tool 510 from local or remote memory or data storage, e.g., local memory 404 and remote server 452) associated with a particular anomaly, the machine learning model can be used by the engineer or user to ascertain the cause or characteristics of a particular anomaly. The machine learning model can be used to guide a review of the visual record with respect to relevant sensor data 502 (and its associated chronologically arranged timestamps) when applied to the video data 504. Thus, the visual record of an anomaly can be studied with respect to relevant sensor data which has been synced in time to the video data 504 such that the reviewer (e.g., user/operator 77) can utilize the machine learning model to analyze the causes of identified anomalous events. Once a cause of an anomalous event has been determined, and a “work around” or an operational resolution to the anomalous event identified, the machine learning model can be trained to provide the operator 77 with the guidance (e.g., using a relevant subroutine) for dealing with the issue associated with the anomalous event. Since all operational steps may be traced back to a generalized process or procedure step, such as, a torque step or a cleaning step, meta-analysis can be performed across all similar steps to identify where, for example, a torque step is more difficult than most typical torque steps—which could indicate that the work or process step instructions themselves need to be improved.

Furthermore, when an reviewer or user wishes to research or review the captured video and sensor data with respect to an identified anomalous event, a selected portion of video data 504 and selected sensor data 502 that is associated with the selected portion of video data 504 can be reviewed by the reviewer or user to determine if, in addition to the identified anomalous event, another or alternative (and as yet unidentified) anomalous event occurred. Such review can result in the identification of a new anomalous event based on evidence contained in either the selected portion of video data 504 and/or the selected sensor data 502 associated with the selected portion of video data 504 (e.g., a new anomalous event can be based upon video data 504 alone, sensor data 502 alone, or a combination of video data 504 and its associated sensor data 502 that was previously associated with an already identified anomalous event). In identifying a new (or additional) anomalous event, the reviewer or user can use the details of the newly identified anomalous event to further train the machine learning model. The machine learning model may be retrained at any interval, ranging from continuous training, to hourly, daily, monthly, yearly, or when model performance is below a certain threshold.

Thus, a manual process guide and monitoring system includes both vision algorithms for monitoring and guiding a worker/operator performing operational steps in a workstation, as well non-vision algorithms for detecting non-visual indicators (acoustic and vibration signals) for detecting the worker/operator performing the operational steps in the workstation. The vision algorithms and the non-vision algorithms provide video data and sensor data that when overlayed, can be used to evaluate the performance of the operational steps to detect the occurrence of anomalies. By identifying certain anomalies in a series of events characterized with video data and sensor data, a machine learning model can be trained by an AI learning processor to autonomously detect the occurrence of certain anomalies in real time as they occur in the performance of the operational steps.

Changes and modifications in the specifically described embodiments can be carried out without departing from the principles of the present invention which is intended to be limited only by the scope of the appended claims, as interpreted according to the principles of patent law including the doctrine of equivalents.

1. A method of evaluating operations performed by an individual comprising:
recording video of actions of the individual with a vision system comprising at least one camera;
overlaying data associated with the performance of the actions by the individual on the recorded video; and
analyzing the recorded video with overlaid data.

2. The method of claim 1, wherein the data comprises sensor data, and wherein the data overlay comprises one or more visual representations of the data on the recorded video, and wherein overlaying the data on the recorded video generates a composite image for analysis.

3. The method of claim 2, wherein the data is overlaid on the recorded video according to chronological order, and wherein the data comprises historical data within each video frame of the recorded video.

4. The method of claim 2, wherein the recorded video is analyzed with the overlaid data to detect anomalies in the performance of operational steps associated with the actions of the individual in a work area.

5. The method of claim 2, wherein the sensor data comprises one or more of: outputs from vision algorithms, input signals from sensors, signals from hardware, signals from the vision system, and data inputs from an acoustic and vibration monitoring system configured to detect and identify acoustic and/or vibration signals associated with the operational steps in the work area.

6. The method of claim 2, wherein the sensor data comprises one or more of: vision tool signals, PLC data bits, recorded torque events from torque sensors and torque guns, recorded torque values, proximity sensor outputs, light curtains and related indications or events, and smart camera outputs.

7. The method of claim 4, wherein the analyzing of the recorded video with the overlaid data is performed with a data processor comprising a machine learning model.

8. The method of claim 7 further comprising training, with an artificial intelligence processor, the machine learning model using sets of selected video data overlaid with respective sets of selected sensor data where a particular same anomaly had been previously identified in each of the sets of selected video data overlaid with respective sets of selected sensor data.

9. The method of claim 4, wherein the analyzing of the recorded video with the overlaid data comprises pattern recognition, such that an end of a current operational step is detected and a next operational step is begun.

10. The method of claim 9 further comprising using a timeline or chronological order of sensor data events in the sensor data to evaluate the recorded video, such that the recorded video is broken down into a series of identified events or steps, as well as identifying those events that signal the beginning and/or ending of the identified events or steps, wherein the identified events comprise data points used during a workflow of the operational steps to advance from operational step to operational step.

11. A manual process guide and monitoring system comprising:
a vision system comprising a camera and a projector, wherein the camera is positioned with respect to a work area and configured to capture video of the actions of a worker, and wherein the projector is configured to guide the worker performing operational steps in the work area;
a controller configured to collect data related to the operational steps performed in the work area;
a data processor configured to analyze video data from the vision system to detect anomalies in the performance of the operational steps in the work area.

12. The manual process guide and monitoring system of claim 11, wherein the data comprises sensor data, and wherein the controller is configured to overlay the data on the video data.

13. The manual process guide and monitoring system of claim 12, wherein the sensor data overlay comprises one or more visual representations of the sensor data on the video data, and wherein the controller is configured to overlay the sensor data on the video data to generate a composite image for analysis.

14. The manual process guide and monitoring system of claim 11, wherein the sensor data is overlaid on the video data according to chronological order, and wherein the data comprises historical data within each video frame of the recorded video.

15. The manual process guide and monitoring system of claim 12, wherein the data processor is configured to analyze the video data along with the sensor data to detect the anomalies in the performance of the operational steps in the work area.

16. The manual process guide and monitoring system of claim 12, wherein the sensor data comprises one or more of: outputs from vision algorithms, input signals from sensors, signals from hardware, signals from the vision system, and data inputs from an acoustic and vibration monitoring system configured to detect and identify acoustic and/or vibration signals associated with the operational steps in the work area.

17. The manual process guide and monitoring system of claim 12, wherein the sensor data comprises one or more of: vision tool signals, PLC data bits, recorded torque events from torque sensors and torque guns, recorded torque values, proximity sensor outputs, light curtains and related indications or events, and smart camera outputs.

18. The manual process guide and monitoring system of claim 11, wherein the data processor comprises a machine learning algorithm or model.

19. The manual process guide and monitoring system of claim 18 further comprising an artificial intelligence processor configured to train the machine learning model using sets of selected video data overlaid with respective sets of selected sensor data where a particular same anomaly had been previously identified in each of the sets of selected video data overlaid with respective set of selected sensor data.

20. The manual process guide and monitoring system of claim 15, wherein the data processor is configured to analyze the video data from the vision system and sensor data from the non-vision system to perform pattern recognition, such that an end of a current operational step is detected and a next operational step begun.

21. The manual process guide and monitoring system of claim 20, wherein the data processor is configured to use a timeline or chronological order of sensor data events in the sensor data to evaluate the video data, such that the video data is broken down into a series of identified events or steps, as well as identifying those events that signal the beginning and/or ending of the identified events or steps, wherein the identified events comprise data points used during a workflow of the operational steps to advance from operational step to operational step.
